(19) United States
(12) Patent Application Publication
(10) Pub. No.: US 2006/0147823 A1
(43) Pub. Date: Jul. 6, 2006

(54) Electrophotographic photoreceptor and charge-transporting material for electrophotographic photoreceptor

(76) Inventors: Tohru Kobayashi, Kanagawa (JP); Yoji Hori, Kanagawa (JP)

Correspondence Address: MCDERMOTT WILL & EMERY LLP, 600 13TH STREET, N.W., WASHINGTON, DC, 20005-3096, US

(21) Appl. No.: 10/546,033

(22) PCT Filed: Feb. 13, 2004
(86) PCT No.: PCT/JP04/01586

§ 371 Date: Aug. 18, 2005

(30) Foreign Application Priority Data
Feb. 18, 2003 (JP) 2003-040120

(51) Int. Cl. G03G 5/047

(52) U.S. Cl. 430/58.85; 430/73

(57) ABSTRACT

A charge transporting material for use in an electrophotographic photoreceptor, which comprises a compound represented by the formula (1); and an electrophotographic photoreceptor using this charge transporting material. As the electrophotographic photoreceptor using the charge transporting material, there are illustrated, for example, a lamination type photoreceptor having a charge generating layer 2 and a charge transporting layer 3 and, as needed, an interlayer 7, and a single layer type photoreceptor. In the formula, R¹ to R⁵ each independently represents a hydrogen atom, an alkyl group, a halogen atom, an alkoxy group, an aryl group or a substituted aryl group, and R⁶ represents a hydrogen atom, an alkyl group, an aryl group or a substituted aryl group.

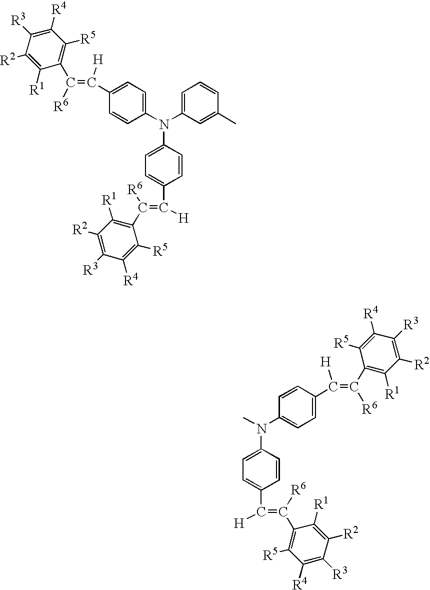

### TECHNICAL FIELD

The present invention relates to an electrophotographic photoreceptor which is favorably used as a photoreceptor in a copying or recording apparatus based on electrophotographic system, such as an electrophotographic copier, a laser beam printer, a printer having a liquid crystal shutter, an LED printer or the like and to a charge transporting material to be used in the photoreceptor.

### BACKGROUND ART

As photoconductive materials in an electrophotographic photoreceptor, there have conventionally been widely used inorganic materials such as selenium, selenium-tellurium, diarsenic triselenide, cadmium sulfide, zinc oxide or amorphous silicon. An electrophotographic photoreceptor using such inorganic photoconductive material, however, has involved such problems as that it has a practically poor flexibility, that it is sensitive to heat or mechanical impact, that its production cost is too high, and that it has some toxicity.

In recent years, various photoreceptors using organic materials have been proposed for solving these problems and have been put into practical use. As one embodiment of the electrophotographic photoreceptors utilizing the organic material, an embodiment wherein the organic photoconductive body is functionally separated into a part of exerting charge transporting function and a part of exerting charge generating function, a so-called function separated type photoreceptor, has been exceedingly examined and the function separated type photoreceptor also has been made practicable (e.g., U.S. Pat. No. 3,791,826, etc.). In the function separated type electrophotographic photoreceptor, a material showing a large carrier-generating efficiency (the term “carrier” means charge; hereinafter the same) is used as a charge generating material, and there is a possibility that a highly sensitive electrophotographic photoreceptor can be obtained by combining the charge generating material with a substance showing a high charge transporting ability as a charge transporting material.

Characteristic properties required for the charge transporting material to be used in such electrophotographic photoreceptor are to effectively receive carriers generated in the charge generating material upon irradiation with light in an electrical field and allow the carriers to move rapidly through the photoreceptor layer for rapid disappearance of surface potential. The speed for the carrier to move per unit electrical field is called “carrier mobility”. High carrier mobility means that the carrier rapidly moves through the charge transporting layer. This carrier mobility is inherent to the charge transporting material. Therefore, in order to attain high carrier mobility, it is necessary to use a material showing high carrier mobility but, under the present circumstances, the carrier mobility is still at an insufficient level.

Also, in the case where the charge transporting material is used by dissolving it in an organic solvent together with a binder polymer to apply, it is required to form a uniform organic thin film without eduction of crystals or formation of pinholes. Because, electric breakdown would take place at a place of such fine crystals or pinholes upon application of a high electrical field to the photoreceptor, or noise would be generated at the place. Further, even when characteristic properties of both of the charge generating material and the charge transporting material are good, it is important that carrier injection from the charge generating material to the charge transporting material be conducted with a high efficiency. Also, in the case where the charge generating material and the charge transporting material are used in different layers, it is important that carrier injection from the charge generating layer to the charge transporting layer be conducted with a high efficiency. This charge injection depends upon a property of the interface between the charge generating material (or charge generating layer) and the charge transporting material (or charge transporting layer), and varies depending upon kinds of materials constituting the interface.

As has been described hereinbefore, the charge transporting material is required to satisfy various requirements. Thus, charge transporting materials having varying properties have been developed, and electrophotographic photoreceptors using them have been put into practical use. As the conventionally proposed charge transporting materials for the electrophotographic photoreceptor, there may be illustrated triarylamine dimmer derivatives represented by the following general formula (A) as described in JP-B-58-32372: 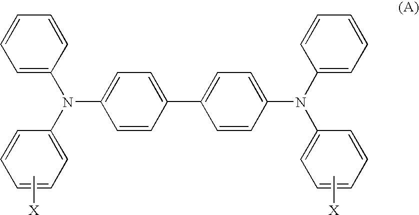
wherein X represents o-CH₃, m-CH₃, p-CH₃, o-Cl, m-Cl or p-Cl.

Also, as other examples, there may be illustrated m-diaminobenzene derivatives represented by the following general formula (B) or (C) as described in JP-A-1-142642, JP-A-5-88389, etc.: 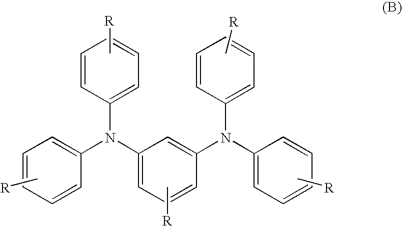
wherein Rs each independently represents an alkyl group, an alkoxy group or a halogen atom, and each phenyl group may not be substituted or may be substituted by any possible number of substituents, with the substituents being the same or different from each other; 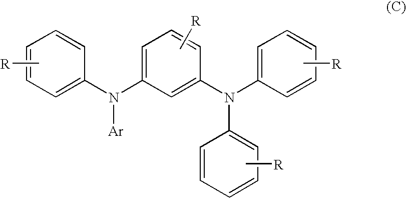
wherein Ar represents a non-condensed or condensed polycyclic hydrocarbyl group other than a phenyl group, Rs may be the same or different from each other and each represents a hydrogen atom, a halogen atom, a cyano group, a nitro group, a substituted or unsubstituted alkyl group, an alkoxy group, an aryl group, an aryloxy group, an alkylmercapto group, an amino group or a methylenedioxy group.

As further examples, there may be illustrated 1, 1, 4, 4-tetraphenyl-1,3-butadiene derivatives represented by the following general formula (D) and tetraphenyl-1,3,5-hexatrienes represented by the following general formula (E) (e.g., JP-B-7-21646 and JP-B-5-19701): 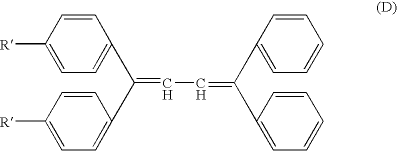
wherein R represents a di-lower alkylamino group, and R′ represents a hydrogen atom or a di-lower alkylamino group; 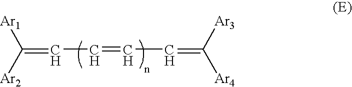
wherein Ar₁, Ar₂, Ar₃ and Ar₄ each represents an aryl group optionally having a substituent, with at least one of Ar₁ to Ar₄ being an aryl group having a substituted amino group as the substituent, and n represents 0 or 1.

Also, many hydrazone derivatives have been described in, for example, JP-B-55-42380, JP-A-57-101844, JP-A-54-150128 and JP-A-61-23154.

However, only a few numbers of the many reported compounds have satisfactory characteristic properties or conditions practically required as a photoreceptor when used in a light-sensitive layer composed of a combination of a charge generating layer and a charge transporting layer. That is, there are involved various problems. For example, crystals are educed after film formation or, even when film formation is well conducted, a sufficient surface potential is not retained in the dark, and the surface potential fails to be fully decreased after irradiation with light (low sensitivity and high residual potential).

The invention has been made in consideration of the above-described problems, and objects of the invention are to provide a charge transporting material for use in an electrophotographic photoreceptor, which can provide a practical electrophotographic photoreceptor showing a high charge mobility, educing no crystals and forming no pinholes upon filming, and providing a light-sensitive layer which is stable and has a high sensitivity and a low residual charge; and to provide an electrophotographic photoreceptor using this charge transporting material.

As a result of eager studies and intensive investigations to solve the above-mentioned problems, the inventors have found that the above-mentioned problems can be solved by incorporating in an electrophotographic photoreceptor, or by using as a charge transporting material, the compound represented by the following formula (1) and reached to the invention.

### DISCLOSURE OF THE INVENTION

The invention is an electrophotographic photoreceptor or a charge transporting material described below as [1] to [5]:
[1] An electrophotographic photoreceptor which contains a compound represented by the formula (1): 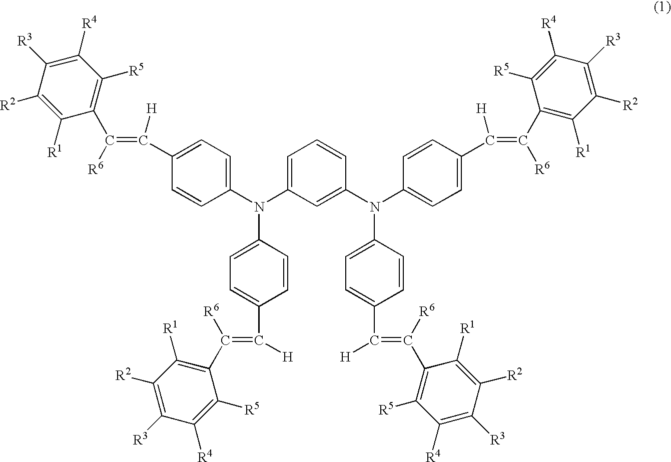
wherein R¹ to R⁵ each independently represents a hydrogen atom, an alkyl group, a halogen atom, an alkoxy group, an aryl group or a substituted aryl group, and R⁶ represents a hydrogen atom, an alkyl group, an aryl group or a substituted aryl group.
[2] An electrophotographic photoreceptor which contains a compound represented by the above formula (1) as a charge transporting material in the light-sensitive layer provided on an electrically conductive support.
[3] An electrophotographic photoreceptor of lamination type having provided on an electrically conductive support a charge generating layer and a charge transporting layer, which contains a compound represented by the above formula (1) as a charge transporting material.
[4] An electrophotographic photoreceptor of single layer type having provided on an electrically conductive support a layer containing both a charge generating material and a charge transporting material, which contains a compound represented by the above formula (1).
[5] A charge transporting material for use in an electrophotographic photoreceptor, which contains a compound represented by the above formula (1).

### BRIEF DESCRIPTION OF THE INVENTION

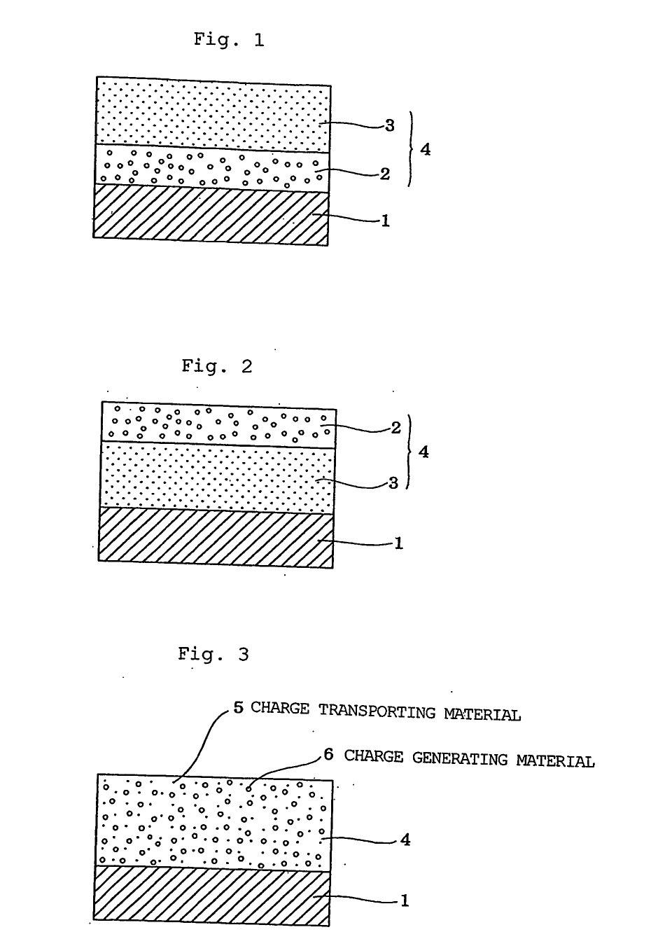

FIG. 1 is a partial schematic cross-sectional view of a lamination type electrophotographic photoreceptor, which shows one example of the layered structure of the lamination type electrophotographic photoreceptor using a charge transporting material of the invention.

FIG. 2 is a partial schematic cross-sectional view of a lamination type electrophotographic photoreceptor, which shows another example of the layered structure of the lamination type electrophotographic photoreceptor using a charge transporting material of the invention.

FIG. 3 is a partial schematic cross-sectional view of a single layer type electrophotographic photoreceptor, which shows an example of the layered structure of the single layer type electrophotographic photoreceptor using a charge transporting material of the invention.

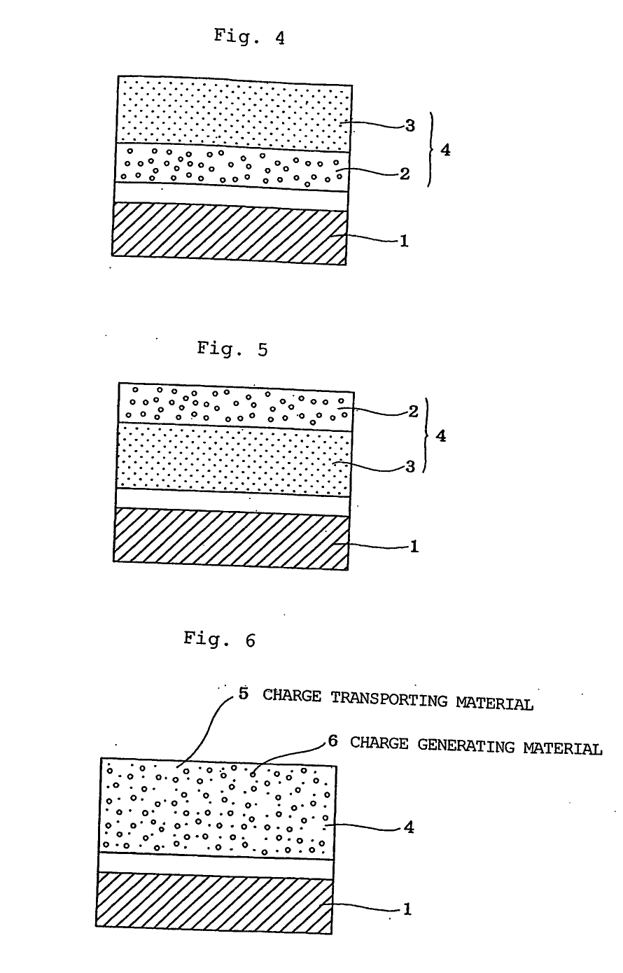

FIG. 4 is a partial schematic cross-sectional view of a lamination type electrophotographic photoreceptor, which shows an example of the layered structure of the lamination type electrophotographic photoreceptor of the invention having an interlayer.

FIG. 5 is a partial schematic cross-sectional view of a lamination type electrophotographic photoreceptor, which shows another example of the layered structure of the lamination type electrophotographic photoreceptor of the invention having an interlayer.

FIG. 6 is a partial schematic cross-sectional view of a single layer type electrophotographic photoreceptor, which shows an example of the layered structure of the single layer type electrophotographic photoreceptor of the invention having an interlayer.

### SPECIFIC EMBODIMENT OF THE INVENTION

The invention is described in more detail below. The electrophotographic photoreceptor of the invention contains a compound represented by the foregoing formula (1) (hereinafter referred to as “compound (1)”), and the charge transporting material of the invention for use in an electrophotographic photoreceptor contains a compound represented by the foregoing formula (1). In the formula (1), an alkyl group of R¹ to R⁵ and R⁶ may be straight, branched or cyclic, and is exemplified by an alkyl group containing 1 to 6 carbon atoms. Specific examples thereof include a methyl group, an ethyl group, a n-propyl group, a 2-propyl group, a n-butyl group, a 2-butyl group, an isobutyl group, a tert-butyl group, a n-pentyl group, a 2-pentyl group, a tert-pentyl group, a 2-methylbutyl group, a 3-methylbutyl group, a 2,2-dimethylpropyl group, a n-hexyl group, a 2-hexyl group, a 3-hexyl group, a tert-hexyl group, a 2-methylpentyl group, a 3-methylpentyl group, a 4-methylpentyl group, a 2-methylpentan-3-yl group, a cyclopropyl group, a cyclobutyl group, a cyclopentyl group and a cyclohexyl group. As the alkyl group, an alkyl group containing 1 to 3 carbon atom is preferred.

Also, examples of a halogen atom of R¹ to R⁵ include a fluorine atom, a chlorine atom, a bromine atom and an iodine atom.

Also, an alkoxy group of R¹ to R⁵ may be straight, branched or cyclic, and is exemplified by an alkoxy group containing 1 to 6 carbon atoms. Specific examples thereof include a methoxy group, an ethoxy group, a n-propoxy group, a 2-propoxy group, a n-butoxy group, a 2-butoxy group, an isobutoxy group, a tert-butoxy group, a n-pentyloxy group, a 2-methylbutoxy group, a 3-methylbutoxy group, a 2,2-dimethylpropyloxy group, a n-hexyloxy group, a 2-methylpentyloxy group, a 3-methylpentyloxy group, a 4-methylpentyloxy group, a 5-methylpentyloxy group and a cyclohexyloxy group. As the alkoxy group, an alkoxy group containing 1 to 3 carbon atom is preferred.

Further, as the aryl group represented by R³ to R⁵ and R⁶, there are illustrated, for example, an aryl group containing 6 to 14 carbon atoms, and specific examples thereof include a phenyl group, a 1-naphthyl group, a 2-naphthyl group and an anthryl group. As the substituted aryl group, there are illustrated those aryl groups which are formed by substituting at least one hydrogen atom of said aryl group by a substituent such as an alkyl group, an aryl group, an alkoxy group, a halogenated alkyl group, a halogen atom, an amino group or a substituted amino group and those aryl groups which are formed by substituting two adjacent hydrogen atoms of said aryl group by a substituent such as analkylenedioxy group. Additionally, the alkyl group, aryl group, alkoxy group and halogen atom referred to as the substituents of the aryl group are the same as those described hereinbefore. As the halogenated alkyl group, there are illustrated those halogenated alkyl groups which are formed by halogenation (e.g., fluorination, chlorination, bromination or iodation) for substituting at least one hydrogen atom of said alkyl group by a halogen atom and which have 1 to 6, preferably 1 to 3, carbon atoms. Specific examples thereof include a chloromethyl group, a bromomethyl group, a trifluoromethyl group, a 2-chloroethyl group, a 3-bromopropyl group and a 3,3,3-trifluoropropyl group. As the alkylenedioxy group, there are illustrated, for example, alkylenedioxy groups having 1 to 3 carbon atoms, and specific examples thereof include a methylenedioxy group, an ethylenedioxy group, a trimethylendioxy group and a propylenedioxy group. As the substituted amino group, there are illustrated those which are formed by substituting one or two hydrogen atoms of an amino group by a substituent such as an alkyl group or an aryl group, with the alkyl group and the aryl group being also the same as mentioned above. Specific examples of an aryl group substituted by an alkyl group include an o-tolyl group, a m-tolyl group, a p-tolyl group, a 2,4-dimethylphenyl group and a mesityl group. Specific examples of an aryl group substituted by an aryl group include a biphenyl group etc.

Specific examples of the compound (1) are shown in the following Table 1. However, it is needless to say that these are mere examples of the compound (1) of the invention, and the compound (1) of the invention is not limited to only those shown in the following table.

TABLE 1

| | | Number of | |
|---|---|---|---|
| | | Substituents | |
| Compound (1) | R¹ to R⁵ | n | R⁶ |
| 1-1 | H | | H |
| | | | H |
| 1-2 | Me (R¹ or R⁵) | 1 | H |
| 1-3 | R²═Me or | 1 | H |
| | R⁴═Me | | |
| 1-4 | R³═Me | 1 | H |
| 1-5 | R¹═R²═Me or | 2 | H |
| | R⁴═R⁵═Me | | |
| 1-6 | R³═Cl | 1 | H |
| 1-7 | R³═OMe | 1 | H |
| 1-8 | R³═Ph | 1 | H |
| 1-9 | H | | Me |
| 1-10 | H | | Et |
| 1-11 | H | | Ph |
| 1-12 | R³═Me | 1 | Ph |
| 1-13 | R³═Me | 1 | p-Tol |
| 1-14 | H | | α-Nap |
| 1-15 | H | | β-Nap |

In the above table, Me represents a methyl group, Ph a phenyl group, Et an ethyl group, p-Tol a 4-methylphenyl group, α-Nap a 1-naphthyl group, and β-Nap a 2-naphthyl group. Also, the number of substituents, n, is a number of substituents of R¹ to R⁵ per phenyl group.

It suffices that at least one of compounds (1) be incorporated in the electrophotographic photoreceptor of the invention, and two or more of them may be incorporated in combination.

The compound (1) may be prepared by, for example, a process shown by the following scheme 1.

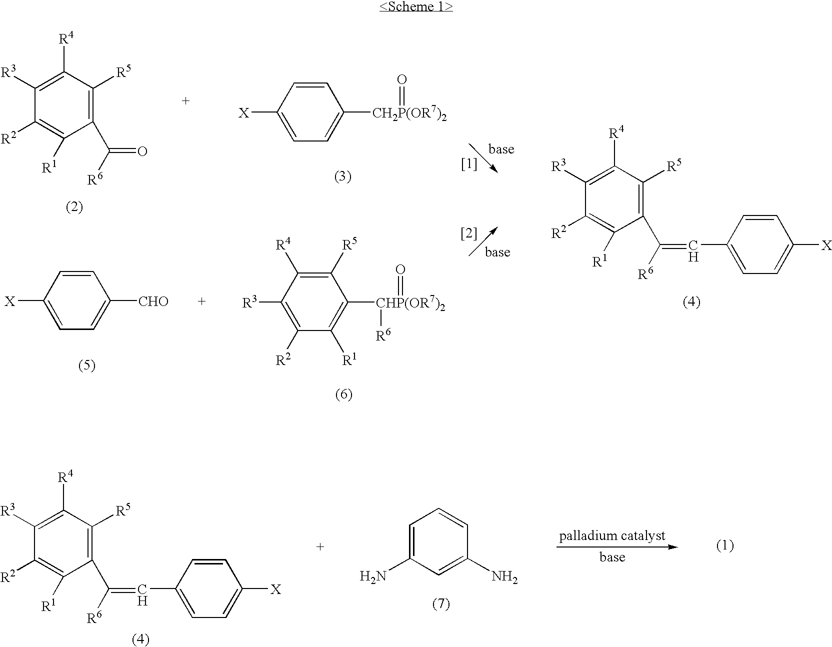

In the above formulae (2) to (7), R¹ to R⁶ are the same as defined hereinbefore, R⁷ represents a methyl group or an ethyl group, and X represents a chlorine atom, a bromine atom or an iodine atom.

That is, first, a halogen-substituted stilbene derivative (4) is synthesized by Wittig-Horner reaction [1] between a carbonyl compound (2) and a p-halogen-substituted benzyl phosphate (3) or [2] between a p-halogenobenzaldehyde (5) and a benzyl phosphate (6). Subsequently, four times the equivalent amount of the thus obtained halogen-substituted stilbene derivative (4) is subjected to a coupling reaction with phenylenediamine (7) in the presence of a palladium catalyst and a base to synthesize an end product of compound (1) with ease. Solvents to be used for these reactions and reaction conditions may be employed according to conventionally known processes. Also, the above-mentioned coupling reaction (carbon-nitrogen bond-forming reaction) using the palladium catalyst may be conducted according to known processes described in, for example, JP-A-2002-187894, Journal of Organic Chemistry (J. Org. Chem.), 2000, vol. 65, p. 5327, Perspectives in Organopalladium Chemistry for the XXI Century (ELSEVIER, p. 125), etc.

It is preferred that, in the electrophotographic photoreceptor of the invention, at least one of the thus-obtained compounds (1) be contained as a charge transporting material. As the type of the electrophotographic photoreceptor of the invention, there are illustrated a lamination type electrophotographic photoreceptor having provided on an electrically conductive support at least a charge generating layer and a charge transporting layer as light-sensitive layers and a single-layer type electrophotographic photoreceptor having provided on an electrically conductive support at least a layer containing both a charge generating material and a charge transporting material as a light-sensitive layer. Constitution of each of these electrophotographic photoreceptors of the invention are further described by reference to Figures. FIGS. 1 and 2 illustrate a partial schematic cross-sectional view of a lamination type electrophotographic photoreceptor. A light-sensitive layer 4 of the photoreceptor in FIG. 1 is constituted by a charge generating layer 2 provided on an electrically conductive support 1 and a charge transporting layer 3 provided on the charge generating layer 2. In a photoreceptor shown in FIG. 2, a charge transporting layer 3 is provided on an electrically conductive support 1, and a charge generating layer 2 is formed on the charge transporting layer 3. Thus, in the lamination type electrophotographic photoreceptor, either of the charge generating layer and the charge transporting layer may be provided nearer to the support, but the photoreceptor shown in FIG. 1 wherein the charge transporting layer is provided on the charge generating layer is more preferred. Also, the single-layer type electrophotographic photoreceptor is a photoreceptor wherein a light-sensitive layer 4 containing at least both a charge generating material 6 and a charge transporting material 5 is provided on an electrically conductive support 1 as shown by the partial schematic cross-section in FIG. 3. Additionally, it suffices for the electrophotographic photoreceptor of the invention to contain the compound (1) in the photoreceptor, but it is preferred to incorporate the compound (1) as a charge transporting material in a light-sensitive layer provided on an electrically conductive support of the electrophotographic photoreceptor.

The electrophotographic photoreceptor of the invention will be specifically described by reference to, first, the lamination type electrophotographic photoreceptor. In the lamination type electrophotographic photoreceptor, a charge generating layer and a charge transporting layer are provided on an electrically conductive support. First, the charge transporting layer is described below. The charge transporting layer can be provided by vacuum-depositing the compound (1) as such on an electrically conductive support or on the charge generating layer, or by dissolving or dispersing the compound (1) and a binder polymer in a proper solvent, coating the solution or dispersion on the electrically conductive support or on the charge generating layer, then drying.

As the binder polymer, any of those which have conventionally been used as binder polymers for a photoreceptor may be used. Needless to say, any of binder polymers which have conventionally been used for forming the charge transporting layer may be used. Specific examples of the binder polymer to be used for forming the charge transporting layer include insulating thermoplastic or thermosetting resins such as (meth)acrylic resins such as polyacrylate and polymethacrylate, polyamide resin, acrylonitrile resin, vinyl chloride resin, acetal resin, butyral resin, vinyl acetate resin, polystyrene resin, polyolefin resin, cellulose ester, phenol resin, epoxy resin, polyester resin, alkyd resin, silicone resin, polycarbonate resin, polyurethane resin, polyimide resin, and copolymers or derivative resins thereof; and photo-setting insulating resins. In addition to these resins, there are illustrated organic photo-conductive polymers such as polyvinylcarbazole, polyvinylanthracene and polyvinylpyrene. These binder polymers may be used independently or in a proper combination of two or more of them. Of these binder polymers, a polycarbonate resin having the repeating unit represented by, for example, the following formula (F) is preferred: 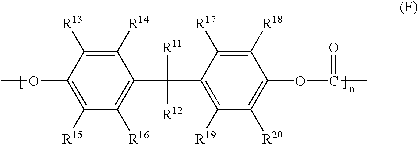
polycarbonate wherein R¹¹ and R¹² each may be the same or different and each represents a hydrogen atom, a lower alkyl group containing 1 to 4 carbon atoms, a lower alkoxy group containing 1 to 4 carbon atoms or a phenyl group optionally substituted by a halogen atom, or may be connected to each other to form a ring, R¹³, R¹⁴, R¹⁵, R¹⁶, R¹⁷, R¹⁸, R¹⁹ and R²⁰ each independently represents a hydrogen atom, a halogen atom, an alkyl group, an alkoxy group or a phenyl group optionally having a substituent, and n represents a positive integer.

Of the polycarbonates represented by the above formula (F), specific preferred examples include bisphenol A type polycarbonates having the repeating unit represented by the following formula (G) (e.g., Iupilon E series made by Mitsubishi Gas Chemical Company, Inc.) and bisphenol Z type polycarbonates having the repeating unit represented by the following formula (H) (e.g., Iupilon Z series made by Mitsubishi Gas Chemical Company, Inc.) and copolymer carbonates having bisphenol A, bisphenol Z and biphenol carbonate as constitutional units (e.g., see JP-A-4-179961).

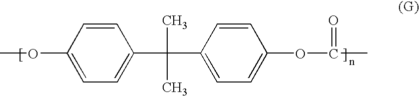

bisphenol A type polycarbonate

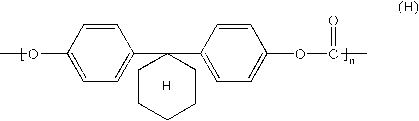

bisphenol Z type polycarbonate

Specific examples of the foregoing biphenol copolymer carbonate include bisphenol/biphenyl type polycarbonate resins represented by the following formula (I) (wherein n/n+m being preferably 0.1 to 0.9), and a more specific example is a bisphenol A/biphenyl type polycarbonate resin represented by the following formula (J) (wherein n/n+m being 0.85).

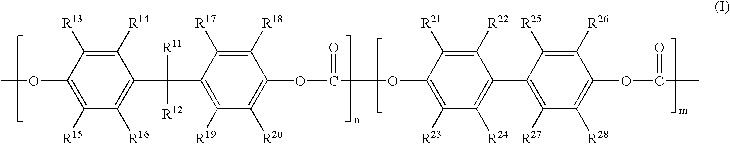

bisphenol/biphenyl type copolymerized polycarbonate

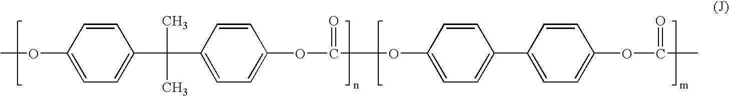

bisphenol A/biphenyl type copolymerized polycarbonate

(n/n+m=0.85)

wherein R¹¹ to R²⁰ are the same as defined hereinbefore, and R²¹, R²², R²³, R²⁴, R²⁵, R²⁶, R²⁷ and R²⁸ each independently represents a hydrogen atom, a halogen atom, an alkyl group, an alkoxy group or a phenyl group optionally having a substituent, with two of R²¹R²², R²³, R²⁴, R²⁵, R²⁶, R²⁷ and R²⁸ being optionally connected to each other independently to form a ring, and n and m each represents a number of moles of the above-described repeating unit.

In addition to the above-described bisphenol/biphenyl type polycarbonate, a polycarbonate whose repeating unit is represented by the following formula (K) (JP-A-6-214412), a polycarbonate whose repeating unit is represented by the following formula (L) (JP-A-6-222581), a high molecular binder having introduced thereinto a siloxane unit represented by the following formula (M) or (N) (JP-A-5-88398, JP-A-11-65136) and the like can also be preferably used.

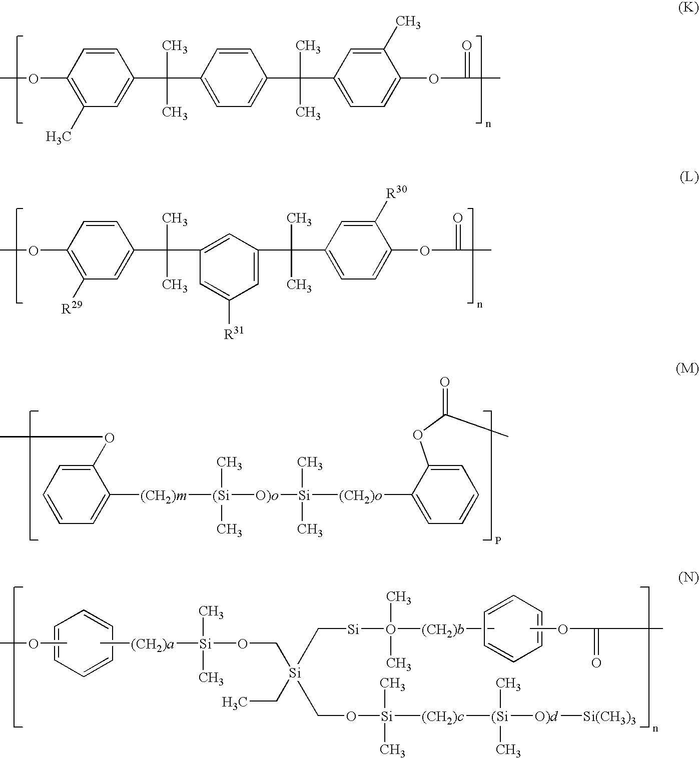

In the above formulae, R²⁹, R³⁰ and R³¹ each independently represents a hydrogen atom, a halogen atom, an alkyl group, a cycloalkyl group, an aryl group or an arylalkyl group, and a, b, c, d, m, n, o and p each represents an integer representing the number of repeating unit.

As to the compounding amounts of the binder polymer and the compound (1), the amount of compound (1) is properly selected in the range of usually from 10 to 1000 parts by weight, preferably from 30 to 500 parts by weight, more preferably from 40 to 200 parts by weight, per 100 parts by weight of the binder polymer.

The solvent for dissolving both the compound (1) and the binder polymer is not particularly limited, but organic solvents are preferred. Examples thereof include alcohols such as methanol, ethanol and isopropanol; ketones such as acetone, methyl ethyl ketone and cyclohexanone; amides such as N,N-dimethylformamide and N,N-dimethylacetamide; sulfoxides such as dimethylsulfoxide; ethers such as tetrahydrofuran, dioxane, dioxolan, ethylene glycol dimethyl ether, diethyl ether, diisopropyl ether and tert-butyl methyl ether; esters such as ethyl acetate and methyl acetate; aliphatic halogenated hydrocarbons such as methylene chloride, chloroform, 1,2-dichloroethane, dichloroethylene, carbon tetrachloride and trichloroethylene; aromatic halogenated hydrocarbons such as chlorobenzene and dichlorobenzene; aromatic hydrocarbons such as benzene, toluene and xylene; and aliphatic hydrocarbons such as pentane, hexane, heptane, octane and cyclohexane. These solvents may be used independently or in a proper combination of two or more of them.

Application of the compound (1) on the electrically conductive support or the charge generating layer is preferably conducted by, for example, dissolving or dispersing the compounds (1), the binder polymer, and, if necessary, other charge transporting material to be described hereinafter and various additives to be described hereinafter to prepare a coating solution or dispersion and applying the resultant solution or dispersion according to a known coating method. As a method for dispersing the ingredients, there may be employed a general dispersing method of using a ball mill, a sand mill, an attritor, a vibration mill or an ultrasonic dispersing machine. As a coating method, there are illustrated, for example, a dip coating method, a spray coating method, a spinner coating method, a wire bar coating method, a blade coating method, a roller coating method and a curtain coating method. The charge transporting layer is formed by drying after the coating procedure. Drying of the coated film is preferably conducted by heat-drying after drying at room temperature. The heat-drying is preferably conducted at a temperature of 30 to 200° C. for a period of from 5 minutes to 2 hours with or without sending air.

As has been described hereinbefore, in the charge transporting layer of the electrophotographic photoreceptor in accordance with the invention, other charge transporting materials may be used, as needed, in combination with the compound (1). Examples of the other charge transporting material include hydrazone compounds represented by the following formula (O) (e.g., JP-B-55-42380, JP-A-60-340999, and JP-A-61-23154), triphenylamine dimmers represented by the following formula (P) (e.g. JP-B-58-32372), distyryl compounds represented by the following formula (O) (e.g. U.S. Pat. No. 3,873,312), tetraphenylbutadiene series compounds, and triphenylmethanes. However, the other charge transporting materials to be used in combination with the compound (1) may be any of those which have conventionally been known as charge transporting materials for electrophotographic photoreceptors and are not limited only to the above-illustrated ones.

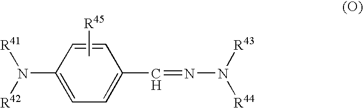

In the above formula (O), R⁴¹ and R⁴² may be the same or different, and each represents a lower alkyl group, an aryl group optionally having a substituent or an aralkyl group optionally having a substituent, R⁴³ and R⁴⁴ may be the same or different, and each represents a lower alkyl group optionally having a substituent, an aryl group optionally having a substituent, an aralkyl group optionally having a substituent or a hetero ring group optionally having a substituent, with R⁴³ and R⁴⁴ optionally being connected to each other to form a ring, R⁴⁵ represents a hydrogen atom, a lower alkyl group, an aryl group optionally having a substituent, an aralkyl group optionally having a substituent, a lower alkoxy group or a halogen atom, with R⁴⁵ and R⁴¹ or R⁴² being optionally connected to each other to form a ring.

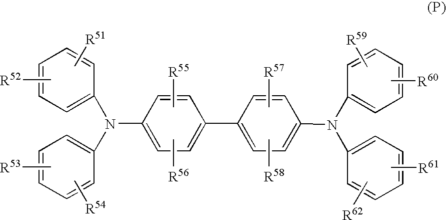

In the above formula (P), R⁵¹ to R⁶² may be the same or different and each represents a hydrogen atom, a lower alkyl group, a lower alkoxy group, a halogen atom-substituted lower alkoxy group, an aryl group optionally having a substituent or a halogen atom.

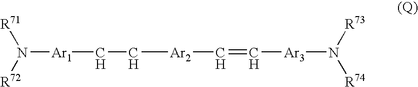

In the above formula (O), R⁷¹ to R⁷⁴ may be the same or different and each represents a lower alkyl group or an aryl group optionally having a substituent, Ar₁, Ar₂ and Ar₃ may be the same or different and each represents a phenylene group optionally having one or more substituents selected from among a lower alkyl group, a lower alkoxy group, an aryloxy group and a halogen atom.

In the charge transporting layer of the electrophotographic photoreceptor of the invention may be incorporated, as needed, various additives in order to more improve charge properties, stability of coating solutions and durability of the photoreceptor. Examples of the additives include plasticizers such as biphenylene compounds, m-terphenyl and dibutyl terephthalate described in JP-A-6-332206; surface lubricants such as silicone oil, graft type silicone polymer and various fluorocarbons; charge stabilizers such as dicyanovinyl compounds and carbazole derivatives; monophenol series antioxidants such as 2,6-di-tert-butyl-4-methylphenol; bisphenol series antioxidants; amine series antioxidants such as 4-diazabiicyclo[2,2,2]octane; salicylic acid series antioxidants; antioxidants such as tocophenol; UV ray absorbents; and sensitizing agents.

The thickness of the charge transporting layer of the electrophotographic photoreceptor of the invention is properly selected in the range of usually from 5 to 40 μm, preferably from 10 to 30 μm.

The thus formed charge transporting layer is electrically connected to the charge generating layer, and thus it functions to receive carriers injected from the charge generating layer in the presence of an electric field and transport the carriers to the other surface of the charge transporting layer. As has been described hereinbefore, the charge transporting layer may be laminated on or under the charge generating layer, but it is desirable for the charge generating layer to be laminated on the charge generating layer.

On the other hand, in the lamination type electrophotographic photoreceptor, the charge generating layer is provided together with the charge transporting layer. As is the same with the charge transporting layer, the charge generating layer is formed by vacuum deposition or coating on an electrically conductive support or on the charge transporting layer. As the charge generating materials to be used in the charge generating layer of the electrophotographic photoreceptor of the invention, any of those may be used which have conventionally been used as charge generating material for electrophotographic photoreceptors. Examples of the charge generating materials to be used in the electrophotographic photoreceptor of the invention include inorganic charge generating materials such as selenium, selenium-tellurium and amorphous silicon and organic charge generating materials such as cationic dyes (e.g., pyrylium salt series dyes, thiapyrylium series dyes, azulenium salt series dyes, thiacyanine series dyes and quinocyanine series dyes), squalium salt series pigments, phthalocyanine series pigments, anthanthrone series pigments, polycyclic quinone pigments (e.g., dibenzpyrene quinone series pigments and pyranthrone series pigments), indigo series pigments, quinacridone series pigments, azo series pigments and pyrrolopyrrole series pigments. These charge generating materials may be used independently or in a proper combination of two or more of them. Of the charge generating materials, organic charge generating materials are preferred, and particularly preferred are those organic charge generating materials which are described in Chemical Review (Chem. Rev.), 1993, vol. 93, pp. 449-486. Specifically, phthalocyanine series pigments, azo series pigments, perylene series compounds and polycyclic quinone series compounds are illustrated as preferred ones. In addition, any material that can absorb light and generate charge in a high yield other than these may be used as well.

The phthalocyanine series pigments, azo pigments, perylene series pigments and polycyclic quinone series compounds to be preferably used in combination with the compound (1) of the charge transporting material of the invention are more specifically described below. First, examples of the phthalocyanine series pigments include alkoxytitanium phthalocianine (Ti(OR)₂Pc), oxotitanium phthalocyanine (TiOPc), copper phthalocyanine (CuPc), metal-free phthalocyanine (H₂Pc), hydroxygallium phthalocyanine (HOGaPc), vanadyl phthalocyanine (VOPc) and chloroindium phthalocyanine (ClInPc). Still more specifically, as TiOPc, there are illustrated α-TiOPc, β-TiOPc, y-TiOPc, m-TiOPc, Y-TiOPc, A-TiOPc, B-TiOPc and amorphous TiOPc and, as H₂Pc, there are illustrated α-H₂Pc, β-H₂Pc, τ-H₂Pc and x-H₂Pc.

Azo pigments include mono-azo compounds, bis-azo compounds and tris-azo compounds. As preferred azo pigments, there are illustrated, for example, bis-azo compounds represented by the following formulae (R), (S) and (T) and tris-azo compounds represented by the formula (U).
Bis-azo Compounds: 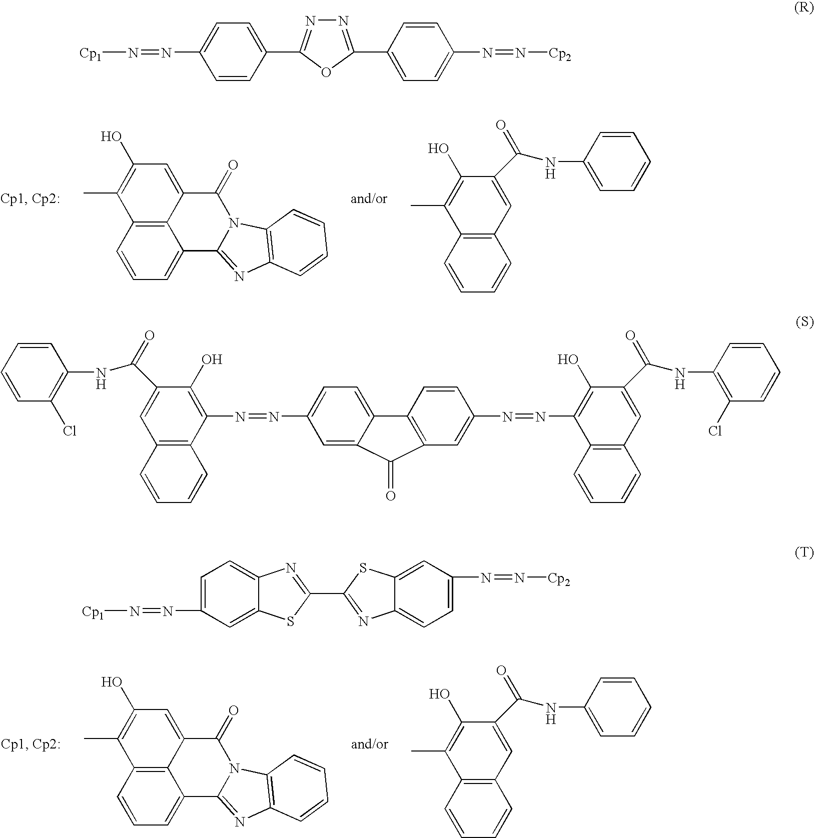
Tris-azo Compounds:

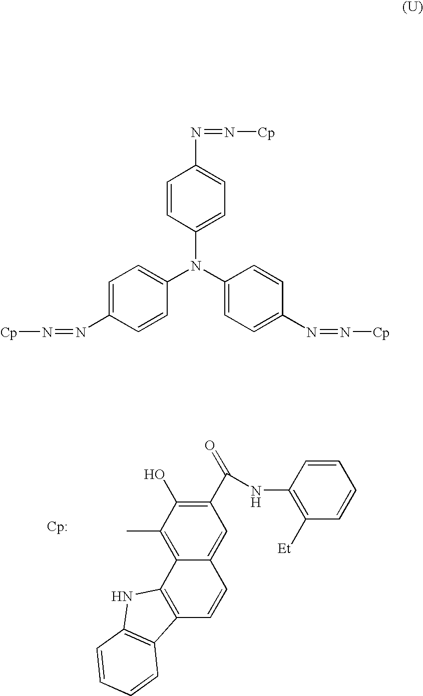

As the perylene compounds, there are illustrated, for example, the perylene series compounds represented by the following formula (V): 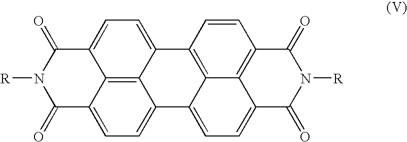
wherein R represents a hydrogen atom, a lower alkyl group or an aryl group optionally having a substituent.

As the polycyclic quinone series compounds, there are illustrated, for example, the polycyclic quinone series compounds represented by the following formula (W):

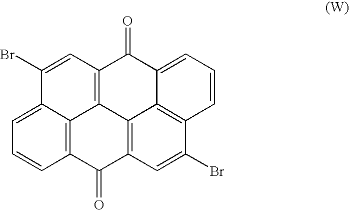

Formation of the charge generating layer by application may be conducted by dissolving or dispersing a charge generating material in a solvent together with a binder polymer and, if necessary, various additives to prepare a coating solution, applying it onto an electrically conductive support or a charge transporting layer, and drying the coat, as is the same with formation of the charge transporting layer. The binder polymer and other additives to be used here may be the same as those which have been referred to with respect to formation of the charge transporting layer. Also, specific methods and conditions for forming the layer may be the same as those employed for forming the charge transporting layer.

Also, in the single-layer electrophotographic photoreceptor of the invention, a light-sensitive layer containing both a charge transporting material including at least compound (1) and a charge generating material is provided on an electrically conductive support. Methods for forming the light-sensitive layer containing both the charge transporting material and the charge generating material and conditions for forming the layer may be the same as the above-mentioned methods and conditions for forming the charge transporting layer and the charge generating layer. As the charge transporting material, the charge generating material, the binder polymer and various additives to be used here, the same ones as are employed for forming the charge transporting layer and the charge generating layer of the above-mentioned function separated type electrophotographic photoreceptor.

Further, as the electrically conductive support to be used in the electrophotographic photoreceptor of the invention, there are illustrated a sheet-shape or drum-shape electrically conductive support made of a metal such as copper, aluminum, silver, iron, zinc or nickel or an alloy thereof, an electrically conductive support made by vacuum-depositing or electrolytic plating of these metals on a plastic film or cylinder, and an electrically conductive support made by providing a layer of electrically conductive polymer or electrically conductive oxide such as indium oxide or tin oxide on a support such as glass, paper or plastic film by coating or vacuum deposition.

In the electrophotographic photoreceptor of the invention, an interlayer 7 having barrier function or adhesion function may be provided, as needed, between the conductive support and the light-sensitive layer provided thereon as shown in FIGS. 4 to 6. The interlayer is provided on the electrically conductive support for the purpose of preventing image defects in reversal development process, coating surface defects on the conductive support, improving chargability, improving adhesion properties of the light-sensitive layer, and improving coating properties of the light-sensitive layer. In the case of forming the interlayer 7, the aforesaid light-sensitive layer is provided on the interlayer 7. As the material for forming the interlayer 7, there are illustrated, for example, polyvinylalcohol, nitrocellulose, casein, ethylene/acrylic acid copolymer, polyamide such as nylon, polyurethane, gelatin and aluminum oxide. The interlayer 7 can be formed by mixing the interlayer-forming material, the above-mentioned solvent and, as needed, metal oxide such as titanium oxide, followed by the same method as with the aforementioned charge transporting layer or the like. The thickness of the interlayer is properly selected in a range of usually from 0.1 to 5 pm, preferably from 0.5 to 3 μm.

Also, in the electrophotographic photoreceptor of the invention, a protective layer may be formed by coating, as needed, on the light-sensitive layer. This protective layer is provided for the purpose of, for example, improving wear resistance of the light-sensitive layer or preventing adverse influence of ozone or nitrogen oxide on the light-sensitive layer.

The compound (1) to be used in the invention as a charge transporting material for use in an electrophotographic photoreceptor shows high charge mobility, and the charge transporting layer or the light-sensitive layer containing it permits to form a uniform coat and attain a high sensitivity and a low residual potential. In addition, the compound (1) shows good coating properties upon forming the coat and has no problems such as eduction of crystals upon forming the charge transporting layer or light-sensitive layer by coating. Thus, the invention enables one to obtain a practical electrophotographic photoreceptor having excellent electrophotographic properties of showing a high sensitivity and a low residual potential and having no pinholes and educed crystals in the formed light-sensitive layer, thus showing good light-sensitive properties and good durability.

### BEST MODE FOR CARRYING OUT THE INVENTION

The invention is now described more specifically by reference to Synthesis Examples, Examples and Comparative Examples which, of course, do not limit the invention in any way.

Additionally, measuring apparatuses and measuring conditions employed in Synthesis Examples are described below.

[¹H-NMR]

Apparatus: Model DRX-500 apparatus (500 MHz) made by Bruker company.

Internal standard substance: tetramethylsilane

Measurement: in heavy chloroform

[Mass analysis (MASS)]

Apparatus: Hitachi M-80B (Hitachi Ltd.)

### SYNTHESIS EXAMPLE 1

### Synthesis of Compound 1-1 [Compound of the Formula (1) Wherein R¹ to R⁵═H and R⁶═H]

(1) Synthesis of 4-bromostilbene [4a; compound of the formula (4) in the synthesis scheme 1 wherein R¹ to R⁵═H, R⁶═H and X═Br]

18 g (0.16 mol) of potassium tert-butoxide was gradually added at 30 to 50° C. to a solution of 15.8 g (0.149 mol) of benzaldehyde and 40.6 g (0.132 mol) of diethyl p-bromobenzylphosphite in 60 ml of N,N-dimethylformamide. Further, 40 ml of N,N-dimethylformamide was added thereto, and the solution was stirred at room temperature for 2 hours to react. The reaction solution was poured into water, extracted with butyl acetate and, after washing twice with water, the extract was dried over magnesium sulfate and concentrated to obtain 33.9 g of crude crystals. Recrystallization of the thus obtained crude crystals from toluene-isopropanol (hereinafter abbreviated as “IPA”) yielded 29.0 g of an end product. Yield: 84.8%; mp: 131-133° C.

¹H-NMR: 7.07 (ABq, d=16.3 Hz, 2H), 7.28 (t, J=7.4 Hz, 1H), 7.32-7.41 (m, 4H), 7.45-7.52 (m, 4H)

MS: 258, 178

(2) Synthesis of Compound 1-1

In a 10-ml eggplant type flask, 8 mg (0.036 mmol) of palladium acetate and 34 mg (0.110 mmol) of a phosphorus ligand represented by the following formula (8) (see JP-A-2002-187894) were charged, and 3 ml of dioxane was added thereto in an atmosphere of nitrogen, followed by heating the mixture to dissolve, thus a catalyst solution being prepared. Subsequently, 2.0 g (18.5 mmol) of m-phenylenediamine [compound (7) in the synthesis scheme 1], 20 g (77.2 mmol) of 4-bromostilbene obtained in the above (1) and 7.8 g (81.2 mmol) of sodium tert-butoxide were charged in a 200-ml flask, and 50 ml of toluene was added thereto in an atmosphere of nitrogen. The above-mentioned catalyst solution was added thereto at room temperature under stirring using a syringe, followed by stirring the mixture for further 10 hours under reflux to react. The reaction solution was poured into water, extracted with toluene and, after washing twice with water, the extract was dried over magnesium sulfate and concentrated to obtain 15.57 g of crude crystals. Recrystallization of the thus obtained crude crystals from toluene yielded 12.57 g of an end product. Yield; 82.8%; mp: 222-225° C.

¹H-NMR: 6.78 (dd, J=8.1 Hz, J=2.2 Hz, 2H), 6.89 (t, J=2.2 Hz, 1H), 6.98-7.04 (m, 7H), 7.09 (d, J=8.7 Hz, 8H), 7.07-7.10 (m, 1H), 7.15 (t, J=8.1 Hz, 1H), 7.23 (t, J=7.3 Hz, 4H), 7.31 (t, J=7.8 Hz, 8H), 7.39 (d, J=8.6 Hz, 8H), 7.45 (d, J=7.2 Hz, 8H)

MS: 820, 602

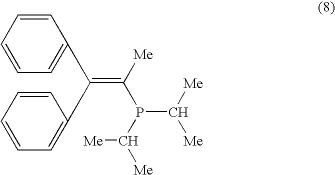

### SYNTHESIS EXAMPLE 2

### Synthesis of Compound 1-2 [Compound of the Formula (1) Wherein R′ or R⁵=Me and R⁶═H]

(1) Synthesis of 4-bromo-2′-methylstilbene [4b; compound of the formula (4) in the synthesis scheme 1 wherein R¹=Me, R² to R⁵═H, R⁶═H, and X═Br]

A mixed solution of 23 g (0.124 mol) of p-bromobenzaldehyde [5a; compound of the formula (5) in the synthesis scheme 1 wherein X═Br; hereinafter the same] and 33 g (0.136 mol) of diethyl o-methylbenzylphosphite [6a; compound of the formula (6) in the synthesis scheme 1 wherein R¹=Me, R² to R⁵═H, R⁶═H, and R⁷=Et] in 70 ml of N,N-dimethylformamide was gradually added to a suspension of 5.7 g (0.143 mol) of 60% sodium hydride in 30 ml of N,N-dimethylformamide at 20 to 30° C. After stirring the mixture for 1 hour at room temperature to react, the reaction solution was poured into water, extracted with toluene and, after washing with water, the extract was dried over magnesium sulfate and concentrated to obtain 36.99 g of crude crystals. Recrystallization of the thus obtained crude crystals from IPA yielded 24.95 g of an end product.

Yield: 73.7%; mp: 67-68° C.

¹H-NMR: 2.41 (s, 3H), 6.92 (d, J=16.2 Hz, 1H), 7.17-7.22 (m, 3H), 7.31 (d, J=16.1 Hz, 1H), 7.38 (d, J=8.4 Hz, 2H), 7.49 (d, J=8.5 Hz, 2H), 7.55-7.59 (m, 1H)

MS: 274, 272, 193, 178, 116, 91

(2) Synthesis of Compound 1-2

A catalyst solution prepared in the same manner as in (2) of Synthesis Example 1 by mixing 10 mg (0.0445 mmol) of palladium acetate, 40 mg (0.129 mmol) of the phosphorus ligand represented by the foregoing formula (8) and 3 ml of dioxane was added to a solution of 1.0 g (9.2 mmol) of m-phenylenediamine [compound (7) in the synthesis scheme 1], 10.5 g (38.4 mmol) of 4-bromo-2′-methylstilbene (4b) and 4.0 g (41.6 mmol) of sodium tert-butoxide in 40 ml of toluene, followed by stirring the mixture for 10 hours under reflux to react. The reaction solution was poured into water, extracted with toluene and, after washing twice with water, the extract was dried over magnesium sulfate and concentrated to obtain 8.63 g of crude crystals. The resultant crude crystals were purified through silica gel column chromatography (eluent: toluene), and further recrystallized from toluene to obtain 4.89 g of an end product. Yield: 60.5%; mp: 218-220° C.

¹H-NMR: 2.40 (s, 12H), 6.79 (dd, J=8.1 Hz, J=2.2 Hz, 2H), 6.91-6.95 (m, 5H), 7.09 (d, J=8.6 Hz, 8H), 7.14-7.19 (m, 13H), 7.21 (s, 2H), 7.23 (s, 2H), 7.40 (d, J=8.6 Hz, 8H), 7.52-7.55 (m, 4H)

MS: 878

### SYNTHESIS EXAMPLE 3

### Synthesis of Compound 1-3 [Compound of the Formula (1) Wherein R² or R⁴=Me, R¹ to R⁵ Other than R² or R⁴═H, and R⁶═H]

(1) Synthesis of 4-bromo-3′-methylstilbene [4c; compound of the formula (4) in the synthesis scheme 1 wherein R² or R⁴=Me, R¹ to R⁵ other than R² or R⁴═H, R⁶═H, and X═Br]

8.5 g (0.213 mol) of 60% sodium hydride, 35 g (0.189 mol) of p-bromobenzaldehyde (5a) and 50 g (0.206 mol) of diethyl m-methylbenzylphosphite [6b; compound of the formula (6) in the synthesis scheme 1 wherein R² or R⁴=Me, R¹ to R⁵ other than R² or R⁴═H, R⁶═H, and R⁷=Et] were mixed, and reaction and after-treatment were conducted in the same manner as in (1) of Synthesis Example 2 to obtain 65 g of crude crystals. Recrystallization of the thus obtained crude crystals from toluene (95 g)-IPA (100 ml) yielded 41.94 g of an end product. Yield: 81.2%; mp: 110-111° C.

¹H-NMR: 2.39 (s, 3H), 6.99-7.11 (m, 3H), 7.21-7.26 (m, 1H), 7.29-7.33 (m, 2H), 7.37 (d, J=8.5 Hz, 2H), 7.48 (d, J=8.5 Hz, 2H)

MS: 274, 272, 193, 178, 165, 152, 115, 91

(2) Synthesis of Compound 1-3

A catalyst solution prepared in the same manner as in (2) of Synthesis Example 1 by mixing 4 mg (0.018 mmol) of palladium acetate, 17 mg (0.055 mmol) of the phosphorus ligand represented by the foregoing formula (8) and 2 ml of dioxane was added to a solution of 1.0 g (9.25 mmol) of m-phenylenediamine [compound (7) in the synthesis scheme 1], 10.5 g (38.4 mmol) of 4-bromo-3′-methylstilbene (4c) and 3.9 g (40.6 mmol) of sodium tert-butoxide in 50 ml of toluene, followed by stirring the mixture for 10 hours under reflux to react. The reaction solution was poured into water, extracted with toluene and, after separation, the toluene layer was washed twice with water, dried over magnesium sulfate and concentrated to obtain 8.39 g of crude crystals. The resultant crude crystals were purified through silica gel column chromatography (eluent: toluene) to obtain 5.44 g of an end product. Further, recrystallization of the product from toluene yielded 5.12 g of an end product. Yield: 63.1%; mp: 178-180° C.

¹H-NMR: 2.32 (s, 12H), 6.77 (dd, J=8.0 Hz, J=2.2 Hz, 2H), 6.92 (t, J=2.1 Hz, 1H), 6.94-7.06 (m, 11H), 7.08 (d, J=8.7 Hz, 8H), 7.12-7.21 (m, 6H), 7.23-7.30 (m, 8H), 7.38 (d, J=8.6 Hz, 8H)

MS: 878

### Synthesis EXAMPLE 4

### Synthesis of Compound 1-9 [Compound of the Formula (1) Wherein R¹ to R⁵═H and R⁶=Me]

(1) Synthesis of 1-(4-bromophenyl)-2-methyl-2-phenylethylene [4d; compound of the formula (4) in the synthesis scheme 1 wherein R¹ to R⁵═H, R⁶=Me and X═Br]

3.6 g (90.0 mmol) of 60% sodium hydride, 15 g (81.1 mmol) of p-bromobenzaldehyde [5a; compound of the formula (5) in the synthesis scheme 1 wherein X═Br] and 20.6 g (85.0 mmol) of diethyl 1-phenylethylphosphite [6c; compound of the formula (6) in the synthesis scheme 1 wherein R¹ to R⁵═H, R⁶=Me and R⁷=Et] were mixed, and reaction and after-treatment were conducted in the same manner as in (1) of Synthesis Example 2 to obtain 22.5 g of crude crystals. Recrystallization of the thus obtained crude crystals from IPA yielded 13.29 g of an end product. Yield: 60.0%; mp: 72-80° C.

¹H-NMR: 2.25 (s, 3H), 6.74 (s, 1H), 7.21 (d, J=8.3 Hz, 2H), 7.28-7.31 (m, 1H), 7.38 (t, J=7.8 Hz, 2H), 7.50 (t, J=8.5 Hz, 4H)

MS: 274, 272, 207, 178, 153, 129, 105, 71

(2) Synthesis of Compound 1-9

A catalyst solution prepared in the same manner as in (2) of Synthesis Example 1 by mixing 4 mg (0.018 mmol) of palladium acetate, 17 mg (0.055 mmol) of the phosphorus ligand represented by the foregoing formula (8) and 2 ml of dioxane was added to a solution of 1.25 g (11.51 mmol) of m-phenylenediamine [compound (7) in the synthesis scheme 1], 13 g (47.6 mmol) of 1-(4-bromophenyl)-2-methyl-2-phenyhlethylene (4d) and 4.8 g (50.0 mmol) of sodium tert-butoxide in 50 ml of xylene, followed by stirring the mixture for 10 hours at 100° C. to react. The reaction solution was poured into water, extracted with toluene and, after washing twice with water, the extract was dried over magnesium sulfate and concentrated to obtain 9.71 g of an oily product. The resultant oily product was purified through silica gel column chromatography (eluent: toluene/hexane=1/1) to obtain 5.2 g of an end product. Further, recrystallization of the product from a toluene-hexane mixed solvent yielded 3.71 g of an end product. Yield: 36.6%; mp: 151-152° C.

¹H-NMR: 2.27 (s, 12H), 6.75-6.79 (m, 6H), 6.97 (t, J=2.1 Hz, 1H), 7.12 (d, J=8.7 Hz, 8H), 7.24-7.29 (m, 13H), 7.34 (t, J=7.9 Hz, 8H), 7.48 (d, J=7.1 Hz, 8H)

MS: 878

### SYNTHESIS EXAMPLE 5

### Synthesis of Compound 1-11 [Compound of the Formula (1) Wherein R¹ to R⁵═H and R⁶=Ph]

(1) Synthesis of 1-(4-bromophenyl)-2-diphenylethylene [4e; compound of the formula (4) in the synthesis scheme 1 wherein R¹ to R⁵═H, R⁶=Ph and X═Br]

20.0 g (0.1081 mol) of p-bromobenzaldehyde [5a; compound of the formula (5) in the synthesis scheme 1 wherein X═Br] and 35.9 g (90%, 0.118 mol) of diethyl diphenylmethylphosphite [6d; compound of the formula (6) in the synthesis scheme 1 wherein R¹ to R⁵═H, R⁶=Ph and R⁷=Et] were dissolved in 60 ml of DMF (dimethylformamide), and 15 g (0.134 mol) of potassium tert-butoxide was gradually added thereto. After stirring the mixture overnight at room temperature, it was poured into water, extracted with toluene, washed twice with water, dried over magnesium sulfate, and concentrated to obtain 36.99 g of a concentrate. The concentrate was purified by reduced pressure distillation to obtain 23.5 g of an end product. Yield: 64.8%; bp: 160-165° C./1 mmHg.

¹H-NMR: 6.89 (d, J=8.4 Hz, 2H), 6.90 (s, 1H), 7.19-7.21 (m, 2H), 7.26 (d, J=8.5 Hz, 2H), 7.30-7.37 (m, 8H)

MS: 334, 253, 239, 226, 215, 202, 189, 178, 165, 151, 139, 126, 113, 101, 88, 77, 63, 51

(2) Synthesis of Compound 1-11

A catalyst solution was prepared from 10 mg (0.027 mmol) of allylpalladium chloride dimer, 31.0 mg (0.10 mmol) of the phosphorus ligand represented by the foregoing formula (8) and 2 ml of dioxane, and was added to a solution of 0.5 g (4.6 mmol) of m-phenylenediamine (7), 6.8 g (20.3 mmol) of 1-(4-bromophenyl)-2-diphenylethylene (4e) and 2.0 g (20.8 mmol) of sodium tert-butoxide in 30 ml of toluene. The reaction was conducted overnight at 100° C., and the mixture was poured into water. Toluene and ethyl acetate were added thereto to extract. The organic layer was washed twice with water, dried over magnesium sulfate, and concentrated to obtain 5.76 g of a product, which was further purified through silica gel column chromatography (eluent: toluene/hexane=1/1) to obtain 3.1 g of an oily product. Crystallization of the product from a toluene-hexane mixed solvent (8 ml/10 ml) yielded 2.86 g of an end product. Yield: 55.2%, mp: 131-132° C.

¹H-NMR: 6.62 (dd, J=8.1 Hz, J-2.0 Hz, 2H), 6.70 (s, 1H), 6.75 (d, J=8.7 Hz, 8H), 6.84 (d, J=8.7 Hz, 8H), 6.89 (s, 4H), 7.01 (t, J=8.1 Hz, 1H), 7.15-7.36 (m, 40H)

MS: 1126

### EXAMPLE 1

One part by weight of α-oxytitanyl phthalocyanine [made by SANYO COLOR WORKS, LTD., α-TiOPc] was added to a binder polymer solution obtained by dissolving 1 part by weight of a butyral resin [Poly(vinyl butyral) BL-1, made by Sekisui Chemical Co., Ltd., hereinafter the same] in 30 parts by weight of tetrahydrofuran, and was dispersed in a vibration mill for 5 hours together with glass beads. This dispersion was applied onto a sheet prepared by vacuum depositing aluminum on a polyethylene terephthalate (hereinafter abbreviated as “PET”) film using a wire bar, followed by drying at 100° C. for 2 hours to form a charge generating layer of about 2 μm in thickness.

Subsequently, 1 part by weight of compound 1-3 obtained in Synthesis Example 3 and 1 part by weight of a polycarbonate resin, Panlite TS-2020 [made by TEIJIN CHEMICALS LTD.; hereinafter the same] were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor A of the invention being prepared.

### EXAMPLE 2

An electrophotographic photoreceptor B of the invention was prepared in the same manner as in Example 1 except for using compound 1-9 in place of compound 1-3.

### CHARACTERISTICS TEST EXAMPLE 1

The electrophotographic characteristics of the electrophotographic photoreceptors A and B obtained in Examples 1 and 2 were measured according to a static system using an electrostatic recording tester model EPA-8200 (made by Kawaguchi Electric Works Co., Ltd.; hereinafter the same). That is, each of the electrophotographic photoreceptors A and B was charged by conducting corona discharge of −6 KV, and the surface potential Vₒ, (unit: −V) was measured. After keeping them for 5 seconds in a dark room (surface potential at this stage: Vi (unit: −V)), they were irradiated with a 5-lux light from a tungsten halogen lamp to determine a half decay exposure E_{1/2} (lux·sec) necessary for reducing the surface potential Vi to a half level, a ⅙ decay exposure E_{1/6} (lux·sec) necessary for reducing the surface potential to one-sixth, and surface residual potential V_{R10} (−V) after irradiating with a 5-lux light for 10 seconds. Results thus obtained are shown in Table 2.

TABLE 2(A)

| | Charge | Charge | | | |
|---|---|---|---|---|---|
| | Generating | Transporting | Vₒ | Vi | V_{R10} |
| | Material | Material | (−V) | (−V) | (−V) |
| Example 1 (A) | α-TiOPc | compound 1-3 | 830 | 668 | 3 |
| Example 2 (B) | α-TiOPc | compound 1-9 | 934 | 740 | 0 |

TABLE 2(B)

| | E_{1/2} (lux · sec) | E_{1/6} (lux · sec) |
|---|---|---|
| Example 1 (A) | 0.47 | 0.78 |
| Example 2 (B) | 0.32 | 0.57 |

### EXAMPLE 3

One part by weight of β-oxytitanyl phthalocyanine [made by SANYO COLOR WORKS, LTD., β-TiOPc] was added to a binder polymer solution obtained by dissolving 1 part by weight of a butyral resin [Poly (vinyl butyral) BL-1] in 30 parts by weight of tetrahydrofuran, and was dispersed in a vibration mill for 5 hours together with glass beads. This dispersion was applied onto a sheet comprising a PET film having vacuum deposited thereon aluminum, using a wire bar, followed by drying at 100° C. for 2 hours to form a charge generating layer of about 2 μm in thickness.

Subsequently, 1 part by weight of compound 1-3 obtained in Synthesis Example 3 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor C of the invention being prepared.

### EXAMPLE 4

A charge generating layer was formed using β-oxytitanyl phthalocyanine (β-TiOPc) on a sheet prepared by vacuum depositing aluminum on a PET film in the same manner as in Example 3. Subsequently, 1 part by weight of compound 1-9 obtained in Synthesis Example 4 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor D of the invention being prepared.

### COMPARATIVE EXAMPLE 1

A charge generating layer was formed on a sheet prepared by vacuum depositing aluminum on a PET film in the same manner as in Example 3 using β-oxytitanyl phthalocyanine (β-TiOPc).

Subsequently, 1 part by weight of comparative compound 1 represented by the following formula and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor a being prepared.

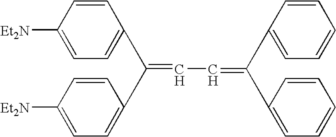

### CHARACTERISTICS TEST EXAMPLE 2

The electrophotographic characteristics of the electrophotographic photoreceptors C, D and a obtained respectively in Examples 3 and 4 and Comparative Example 1 were measured by a static system in the same manner as in Characteristics Test Example 1 using an electrostatic recording tester model EPA-8200. Results thus obtained are shown in Table 3.

TABLE 3(A)

| | Charge | Charge | | | |
|---|---|---|---|---|---|
| | Generating | Transporting | Vₒ | Vi | V_{R10} |
| | Material | Material | (−V) | (−V) | (−V) |
| Example 3 (C) | β-TiOPc | compound 1-3 | 501 | 361 | 0 |
| Example 4 (D) | β-TiOPc | compound 1-9 | 542 | 417 | 0 |
| Com. Ex. 1 (a) | β-TiOPc | comparative | 722 | 538 | 3 |
| | | compound 1 | | | |

TABLE 3(B)

| | E_{1/2} (lux · sec) | E_{1/6} (lux · sec) |
|---|---|---|
| Example 3 (C) | 0.89 | 2.01 |
| Example 4 (D) | 0.90 | 2.03 |
| Com. Ex. 1 (a) | 1.01 | 2.15 |

As is apparent from Table 3, it is seen that the electrophotograpic photoreceptors C and D of the invention showed a higher sensitivity (smaller value of E_{1/2} and E_{1/6}) and smaller residual potential than those of the electrophotographic photoreceptor a using the comparative compound 1. These data demonstrate the excellence of the electrophotographic photoreceptors of the invention.

### EXAMPLE 5

One part by weight of crystalline oxytitanyl phthalocyanine (TiOPc crystals) prepared according to the process described in JP-A-63-20365 was added to a binder polymer solution obtained by dissolving 1 part by weight of a butyral resin [Poly (vinyl butyral) BL-1] in 30 parts by weight of tetrahydrofuran, and was dispersed in a vibration mill for 5 hours together with glass beads. This dispersion was applied onto a sheet prepared by vacuum depositing aluminum on a PET film, using a wire bar, followed by drying at 100° C. for 2 hours to form a charge generating layer of about 2 μm in thickness.

Subsequently, 1 part by weight of compound 1-3 obtained in Synthesis Example 3 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor E of the invention being prepared.

### EXAMPLE 6

A charge generating layer of about 2 μm in thickness was formed using crystalline oxytitanyl phthalocyanine (TiOPc crystals) on a sheet prepared by vacuum depositing aluminum on a PET film in the same manner as in Example 5.

Subsequently, 1 part by weight of compound 1-9 obtained in Synthesis Example 4 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor F of the invention being prepared.

### COMPARATIVE EXAMPLE 2

A charge generating layer (about 2 μm in thickness) was formed using crystalline oxytitanyl phthalocyanine (TiOPc crystals) on a sheet prepared by vacuum depositing aluminum on a PET film in the same manner as in Example 5.

Subsequently, 1 part by weight of comparative compound 2 represented by the following formula and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor b being prepared.

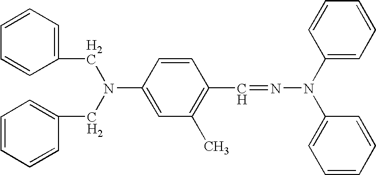

### CHARACTERISTICS TEST EXAMPLE 3

The electrophotographic characteristics of the electrophotographic photoreceptors E, F and b obtained respectively in Examples 5 and 6 and Comparative Example 2 were measured by a static system in the same manner as in Characteristics Test Example 1 using an electrostatic recording tester model EPA-8200. Results thus obtained are shown in Table 4.

TABLE 4(A)

| | Charge | Charge | | | |
|---|---|---|---|---|---|
| | Generating | Transporting | Vₒ | Vi | V_{R10} |
| | Material | Material | (−V) | (−V) | (−V) |
| Example 5 (E) | TiOPc | compound 1-3 | 698 | 589 | 3 |
| | crystals | | | | |
| Example 6 (F) | TiOPc | compound 1-9 | 713 | 570 | 0 |
| | crystals | | | | |
| Com. Ex. 2 (b) | TiOPc | comparative | 787 | 678 | 15 |
| | crystals | compound 2 | | | |

TABLE 4(B)

| | E_{1/2} (lux · sec) | E_{1/6} (lux · sec) |
|---|---|---|
| Example 5 (E) | 0.41 | 0.87 |
| Example 6 (F) | 0.36 | 0.75 |
| Com. Ex. 2 (b) | 0.85 | 2.01 |

As is apparent from Table 4, it is seen that the electrophotographic photoreceptors E and F of the invention showed a higher sensitivity (smaller value of E_{1/2} and E_{1/6}) and smaller residual potential than those of the electrophotographic photoreceptor b using the comparative compound 2. These data demonstrate the excellence of the electrophotographic photoreceptors of the invention.

### EXAMPLE 7

One part by weight of x-type metal-free phthalocyanine (x-H₂Pc) was added to a binder polymer solution obtained by dissolving 1 part by weight of a butyral resin [Poly(vinyl butyral) BL-1] in 30 parts by weight of tetrahydrofuran, and was dispersed using a vibration mill for 5 hours together with glass beads. This dispersion was applied onto a sheet prepared by vacuum depositing aluminum on a PET film, using a wire bar, followed by drying at 100° C. for 2 hours to form a charge generating layer of about 2 μm in thickness.

Subsequently, 1 part by weight of compound 1-3 obtained in Synthesis Example 3 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor G of the invention being prepared.

### EXAMPLE 8

A charge generating layer (about 2 μm in thickness) was formed using x-type metal-free phthalocyanine (x-H₂Pc) on a sheet prepared by vacuum depositing aluminum on a PET film in the same manner as in Example 7.

Subsequently, 1 part by weight of compound 1-9 obtained in Synthesis Example 4 and 1 part by weight of a polycarbonate resin, PanliteTS-2020 made by TEIJIN CHEMICALS LTD. were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor H of the invention being prepared.

### COMPARATIVE EXAMPLE 3

A charge generating layer (about 2 μm in thickness) was formed using x-type metal-free phthalocyanine (x-H₂PC) on a sheet prepared by vacuum depositing aluminum on a PET film in the same manner as in Example 7.

Subsequently, 1 part by weight of comparative compound 3 represented by the following formula and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor c being prepared.

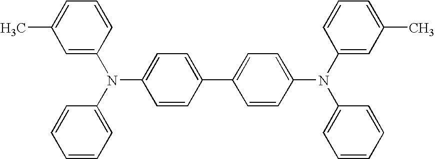

### COMPARATIVE EXAMPLE 4

A charge generating layer (about 2 μm in thickness) was formed using x-type metal-free phthalocyanine (x-H₂PC) on a sheet prepared by vacuum depositing aluminum on a PET film in the same manner as in Example 7.

Subsequently, 1 part by weight of the above-described comparative compound 1 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor d being prepared.

### COMPARATIVE EXAMPLE 5

A charge generating layer (about 2 μm in thickness) was formed using x-type metal-free phthalocyanine (x-H₂Pc) on a sheet prepared by vacuum depositing aluminum on a PET film in the same manner as in Example 7.

Subsequently, 1 part by weight of the above-described comparative compound 2 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor e being prepared.

### CHARACTERISTICS TEST EXAMPLE 4

The electrophotographic characteristics of the electrophotographic photoreceptors G, H, c, d and e obtained respectively in Examples 7 and 8 and Comparative Examples 3, 4 and were measured by a static system using an electrostatic recording tester model EPA-8200 in the same manner as in Characteristics Test Example 1. Results thus obtained are shown in Table 5.

TABLE 5(A)

| | Charge | Charge | | | |
|---|---|---|---|---|---|
| | Generating | Transporting | Vₒ | Vi | V_{R10} |
| | Material | Material | (−V) | (−V) | (−V) |
| Example 7 (G) | x-H₂Pc | compound 1-3 | 986 | 861 | 0 |
| Example 8 (H) | x-H₂Pc | compound 1-9 | 1059 | 950 | 0 |
| Com. Ex. 3 (c) | x-H₂Pc | comparative | 1087 | 971 | 5 |
| | | compound 3 | | | |
| Com. Ex. 4 (d) | x-H₂Pc | comparative | 846 | 757 | 0 |
| | | compound 1 | | | |
| Com. Ex. 5 (e) | x-H₂Pc | comparative | 1066 | 944 | 27 |
| | | compound 2 | | | |

TABLE 5(B)

| | E_{1/2} (lux · sec) | E_{1/6} (lux · sec) |
|---|---|---|
| Example 7 (G) | 0.79 | 1.54 |
| Example 8 (H) | 0.83 | 1.66 |
| Com. Ex. 3 (c) | 1.07 | 1.95 |
| Com. Ex. 4 (d) | 1.07 | 2.08 |
| Com. Ex. 5 (e) | 1.34 | 3.27 |

As is apparent from Table 5, it is seen that the electrophotographic photoreceptors G and H of the invention showed a higher sensitivity (smaller value of E_{1/2} and E_{1/6}) and smaller residual potential than those of the electrophotographic photoreceptors c, d and e using respectively the comparative compounds 3, 1 and 2. These data demonstrate the excellence of the electrophotographic photoreceptors of the invention.

### EXAMPLE 9

One part by weight of τ-type metal-free phthalocyanine (τ-H₂Pc) was added to a binder polymer solution obtained by dissolving 1 part by weight of a butyral resin [Poly(vinyl butyral) BL-1] in 30 parts by weight of tetrahydrofuran, and was dispersed using a vibration mill for 5 hours together with glass beads. This dispersion was applied onto a sheet prepared by vacuum depositing aluminum on a PET film using a wire bar, followed by drying at 100° C. for 2 hours to form a charge generating layer of about 2 μm in thickness.

Subsequently, 1 part by weight of compound 1-3 obtained in Synthesis Example 3 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor I of the invention being prepared.

### EXAMPLE 10

A charge generating layer (about 2 μm in thickness) was formed using τ-type metal-free phthalocyanine (τ-H₂Pc) on a sheet prepared by vacuum depositing aluminum on a PET film in the same manner as in Example 9.

Subsequently, 1 part by weight of compound 1-9 obtained in Synthesis Example 4 and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor J of the invention being prepared.

### COMPARATIVE EXAMPLE 6

A charge generating layer (about 2 μm in thickness) was formed using τ-type metal-free phthalocyanine (τ-H₂Pc) on a sheet prepared by vacuum depositing aluminum on a PET film in the same manner as in Example 9.

Subsequently, 1 part by weight of comparative compound 4 represented by the following formula and 1 part by weight of a polycarbonate resin, Panlite TS-2020 were mixed and dissolved in 8 parts by weight of 1,2-dichloroethane. This solution was applied onto the formerly formed charge generating layer using a doctor blade, and dried at 80° C. for 3 hours to form a charge transporting layer of about 20 μm in thickness, thus an electrophotographic photoreceptor f being prepared.

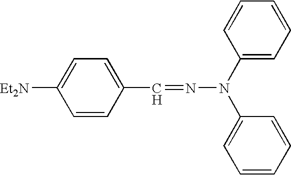

### CHARACTERISTICS TEST EXAMPLE 5

The electrophotographic characteristics of the electrophotographic photoreceptors I, J and f obtained respectively in Examples 9 and 10 and Comparative Example 6 were measured by a static system using an electrostatic recording tester model EPA-8200 in the same manner as in Characteristics Test Example 1. Results thus obtained are shown in Table 6.

TABLE 6(A)

| | Charge | Charge | | | |
|---|---|---|---|---|---|
| | Generating | Transporting | Vₒ | Vi | V_{R10} |
| | Material | Material | (−V) | (−V) | (−V) |
| Example 9 (I) | τ-H₂Pc | compound 1-3 | 918 | 714 | 2 |
| Example 10 (J) | τ-H₂Pc | compound 1-9 | 859 | 659 | 16 |
| Com. Ex. 6 (f) | τ-H₂Pc | comparative | 475 | 149 | 29 |
| | | compound 4 | | | |

TABLE 6(B)

| | E_{1/2} (lux · sec) | E_{1/6} (lux · sec) |
|---|---|---|
| Example 9 (I) | 1.02 | 2.28 |
| Example 10 (J) | 1.05 | 2.48 |
| Com. Ex. 6 (f) | 4.59 | too small to measure |

As is apparent from Table 6, it is seen that the electrophotographic photoreceptors I and J of the invention showed a higher sensitivity (smaller value of E_{1/2} and E_{1/6}) and smaller residual potential than those of the electrophotographic photoreceptor f using the comparative compound 4. These data demonstrate the excellence of the electrophotographic photoreceptors of the invention.

### EXAMPLE 11

One part by weight of compound 1-3 obtained in Synthesis Example 3 and 1 part by weight of a polycarbonate resin, Panlite TS-2020 were mixed and dissolved in 8 parts by weight of 1,2-dichloroethane. This solution was applied onto a sheet prepared by vacuum depositing aluminum on a PET film using a doctor blade, and dried at 80° C. for 2 hours to form a charge transporting layer of about 20 μm in thickness, thus an electrophotographic photoreceptor K of the invention being prepared.

### EXAMPLE 12

An electrophotographic photoreceptor L was prepared in the same manner as in Example 11 except for using compound 1-9 obtained in Synthesis Example 4 in place of compound 1-3.

### COMPARATIVE EXAMPLE 7

An electrophotographic photoreceptor g was prepared in the same manner as in Example 11 except for using the foregoing comparative compound 1 in place of compound 1-3.

### COMPARATIVE EXAMPLE 8

An electrophotographic photoreceptor h was prepared in the same manner as in Example 11 except for using the comparative compound 5 represented by the following formula in place of compound 1-3.

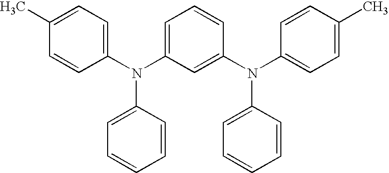

### CHARACTERISTICS TEST EXAMPLE 6

The charge carrier mobility was measured with the electrophotographic photoreceptors K, L, g and h obtained in Examples 11 and 12 and Comparative Examples 7 and 8, respectively, by vacuum depositing a semi-transparent gold electrode on the charge transporting layer formed in each of these electrophotographic photoreceptors. Measurement of the carrier mobility was conducted according to the time-of-flight method (see, for example, Somei Tanaka, Yasuhiro Yamaguchi and Masaaki Yokoyama, Electrophotography, 29, p. 366 (1990)) using as a light source a nitrogen gas laser of 0.9 nsec in pulse half width and 337 nm in wave-length. Results of the measurement conducted at 25° C. and 25 V/μm are shown in Table 7.

TABLE 7

| | Charge Transporting | Carrier Mobility |
|---|---|---|
| | Material | (cm²/Vs) |
| Example 11 | compound 1-3 | 2.81 × 10⁻⁵ |
| Example 12 | compound 1-9 | 2.37 × 10⁻⁵ |
| Com. Ex. 7 | comparative compound 1 | 0.67 × 10⁻⁵ |
| Com. Ex. 8 | comparative compound 5 | 0.98 × 10⁻⁵ |

As is apparent from Table 7, it is seen that the charge transporting materials to be used in the electrophotographic photoreceptor of the invention showed larger carrier mobility than those of the comparative compounds 1 and 5. These data demonstrate the excellence of the electrophotographic photoreceptors of the invention.

Additionally, all of the charge transporting layers formed in Examples 1 to 12 showed good coating properties, and none of them suffered eduction of crystals of the charge transporting material and formation of pinholes.

### ADVANTAGES OF THE INVENTION

The charge transporting materials of the invention for use in electrophotographic photoreceptors have high carrier mobility, and the electrophotographic photoreceptor of the invention using the charge transporting material of the invention has good film stability, attains a high sensitivity and a low residual potential, thus being industrially excellent.

### INDUSTRIAL APPLICABILITY

As has been described hereinbefore, the electrophotographic photoreceptor of the invention can advantageously be used as a photoreceptor for use in a copying and/or recording apparatus based on electrophotographic process such as an electrophotographic copying machine, a laser beam printer, a printer having a liquid crystal shutter, and an LED printer. Additionally, the charge transporting materials of the invention for use in electrophotographic photoreceptors are advantageously used as charge transporting materials to be used in the light-sensitive layer of these electrophotographic photoreceptors.

1. An electrophotographic photoreceptor which contains a compound represented by the formula (1): 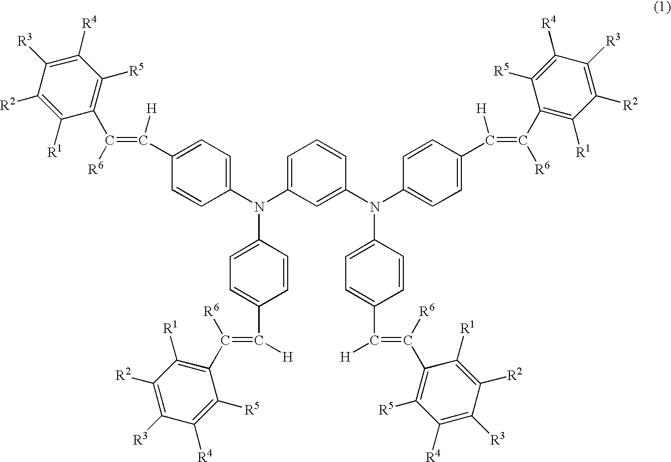
wherein R¹ to R⁵ each independently represents a hydrogen atom, an alkyl group, a halogen atom, an alkoxy group, an aryl group or a substituted aryl group, and R⁶ represents a hydrogen atom, an alkyl group, an aryl group or a substituted aryl group.

2. An electrophotographic photoreceptor which contains a compound represented by the above formula (1) as a charge transporting material in the light-sensitive layer provided on an electrically conductive support.

3. An electrophotographic photoreceptor of lamination type having provided on an electrically conductive support a charge generating layer and a charge transporting layer, which contains a compound represented by the above formula (1) as a charge transporting material.

4. An electrophotographic photoreceptor of single layer type having provided on an electrically conductive support a layer containing both a charge generating material and a charge transporting material, which contains a compound represented by the above formula (1).

5. A charge transporting material for use in an electrophotographic photoreceptor, which comprises a compound represented by the above formula (1).
